(19) United States
(12) Patent Application Publication
(10) Pub. No.: US 2015/0373083 A1
(43) Pub. Date: Dec. 24, 2015

(54) ELECTRONIC DEVICES FOR, A SYSTEM AND A METHOD OF CONTROLLING ONE OF THE ELECTRONIC DEVICES

(71) Applicant: KONINKLIJKE PHILIPS N.V., Eindhoven (NL)

(72) Inventors: LUCAS JACOBUS FRANCISCUS GEURTS, BEST (NL); JOHAN PARTOMO DJAJADININGRAT, UTRECHT (NL)

(21) Appl. No.: 14/653,864

(22) PCT Filed: Dec. 18, 2013
(86) PCT No.: PCT/EP2013/077011

§ 371 Date: Jun. 19, 2015

(30) Foreign Application Priority Data
Dec. 21, 2012 (EP) 12198938.8

(51) Int. Cl. H04L 29/08; G06F 3/0481

(52) U.S. Cl. CPC H04L 67/025; G06F 3/0481

(57) ABSTRACT

A first electronic device 110, a second electronic device 130 and a system 100 comprising the first and the second electronic device 110, 130 are provided. Also a method of controlling the first electronic device 100 and a computer program for performing the method are provided. The first electronic device 100 and the second electronic device 130 each comprise a body coupled communication interface 116, 134 and when a user 150 is in the direct vicinity of both body coupled communication interfaces 116, 134, the first electronic device 110 transmits via a body transmission channel 160 identification data 112 to the second electronic device 130. Subsequently the second electronic device 130 obtains on basis of the received identification data a control user interface. The obtained control user interface is presented on a user interface presentor 138 of the second electronic device.

### FIELD OF THE INVENTION

The invention relates to a first and a second electronic device which comprises an interface for using a body transmission channel as a communication channel. The invention further relates to a system for controlling the first electronic device and to a method of controlling the first electronic device.

### BACKGROUND OF THE INVENTION

For decades electronic devices are controllable with other electronic device such as a remote controller. Traditionally, control information is communicated by means of infrared light on basis of a communication protocol that has been specifically designed for the electronic device.

More recently, universal remote controllers became available. The universal remote controllers are capable of communicating control information to many different electronic devices because it has knowledge about the communication protocol of these specific electronic devices. The user has to preselect the electronic device he wants to control before he is capable of using the universal remote controller with the electronic device. The pre-selection by the user is not a very convenient solution, especially not when the universal remote controller is being used in combination with many different electronic devices.

Today several interactive electronic devices, like tablets and/or smart phones, have an infrared transceiver such that via infrared light information may be transmitted to the other electronic devices. It is known that a user may install an application on these interactive electronic devices such that the interactive electronic devices may be used as a remote controller for electronic devices which are traditionally controlled with control data that is being transmitted via an infrared based communication channel. Also on such interactive electronic device the user has to provide user input to the application about which electronic device is going to be controlled such that the application is capable of selecting the correct user interface and using the required communication protocol over the infrared light communication channel.

### SUMMARY OF THE INVENTION

It is an object of the invention to provide a user friendly solution for controlling an electronic device with another device.

A second electronic device in accordance with an aspect of the invention comprises a user interface presentor, an input reception means, a second body coupled communication interface and a controller. The user interface presentor is capable of presenting a user interface to a user. The input reception means receives user input from the user. The second body coupled communication interface receives identification data via a body transmission channel following a body of a user who is simultaneously with his body in the direct vicinity of the first body coupled communication interface and the second body coupled communication interface. The direct vicinity of the body with respect to the respective body coupled communication interfaces is defined as a maximum distance between the body of the user and, respectively, the first body coupled communication interface and the second body coupled communication interface at which the respective body coupled communication interfaces are capable of transmitting and/or receiving data via the body transmission channel. The controller obtains a control user interface related to the first electronic device in response to the reception of the identification data of the first electronic device. The controller also presents the obtained control user interface on the user interface presentor.

When a user touches, in an intuitive way, the first electronic device and the second electronic device, or when the user is in the direct vicinity of the first electronic device and the second electronic device, the second electronic device is capable of obtaining the control user interface which relates to the first electronic device and presents this control user interface. Thus, the user does not have to select which type of or which specific first electronic device is going to be controlled because this information is received via the body transmission channel. Thus, when the second electronic device is used in combination with another electronic device which is capable of transmitting identification data via the body transmission channel, the second electronic device provides an intuitive solution for indicating with a touch or a direct vicinity which electronic device is going to be controlled and the second electronic device provides the control user interface and provides means to provide input in relation to the control user interface.

The user interface presentor may be any means which is capable of presenting a user interface such that a user is capable of perceiving the user interface. This means that the user interface presentor may be a display, but it may also be an audio system which presents the user interface in an audible way.

Optionally, the maximum distance is closer than 5 cm. Optionally, the maximum distance is closer than 2 cm. In an optional embodiment of the invention, direct vicinity means that the user touches the first body coupled communication interface and touches the second body coupled communication interface.

It is to be noted that the term “obtain” is used in the context of “obtaining the control user interface related to the first electronic device”. In the following of this document several embodiments are discussed which present different forms of obtaining Within the meaning of this document “obtaining” needs to be interpreted as a broad term which also covers the actions of selecting, downloading and/or retrieving the appropriate control user interface, and/or requesting and receiving the appropriate control user interface.

Optionally, the second electronic device is configured to transmit control data to the first electronic device after user input related to the presented control user interface has been received. The control data is based on the received user input. Thus, when the user provides input to the input reception means, the second electronic device generates the control data and transmits this to the first electronic device. Thus, the second electronic device becomes a sort of universal remote controller for the first electronic device while the user doesn't have to preselect which type of device or which specific first electronic device is going to be controlled.

Optionally, the second body coupled communication interface is configured to transmit control data via the body transmission channel following the body of the user who is simultaneously in the direct vicinity of the first body coupled communication interface and the second body coupled communication interface. Consequently, as well as the first electronic device as the second electronic device does not need to have additional communication means. The provided body coupled communication interfaces are in principle enough to communicate control information between the electronic devices.

Optionally, the controller is configured to obtain the control user interface related to the first electronic device from an internal storage of the second electronic device, from the first electronic device via the body transmission channel or another communication channel between the first electronic device and the second electronic device, or from a server via a network. Thus, optionally, the second electronic device comprises a storage means, other means to communicate with the first electronic device and/or a network connection to the network. When the control user interface, which relates to the first electronic device, is stored in the internal storage means of the second electronic device it is most efficient to obtain the stored control user interface and present this one with help of the user interface presentor. It might be that the first electronic device has knowledge about its own control user interface and that the first electronic device is capable of providing this control user interface in a specific script or programming language to the second electronic device. The body transmission channel may be used, or, if for example another (wireless) connection is being created between the first electronic device and the second electronic device, via such another (wireless) connection. It might also be that a server is available which comprises different control user interfaces and that the second electronic device may contact such a server to download the control user interface which relates to the first electronic device. It is to be noted that such a control user interface is most probably a piece of programming code, or a script, or for example a sort of homepage in a mark-up language.

An aspect of the invention provides a first electronic device. An aspect of the invention provides a second electronic device. An aspect of the invention provides a system for controlling the first electronic device. An aspect of the invention provides a method of controlling the first electronic device. An aspect of the invention provides a computer program product. Advantageous embodiments are defined in the dependent claims.

A first electronic device in accordance with an aspect of the invention comprises a first body coupled communication interface. The first body coupled communication interface is configured to transmit identification data relating to an identity of the first electronic device via a body transmission channel following a body of a user who is in the direct vicinity of the first body coupled communication interface. The direct vicinity of the body to the first body coupled communication interface is defined as maximum distance between the body of the user and the first body coupled communication interface at which the first body coupled communication interface is capable of transmitting and/or receiving data via the body transmission channel. The first electronic device is configured to, after transmitting the identification data, to receive control data and is configured to control the operation of the first electronic device accordingly.

Thus, when a user, is in the direct vicinity of the first body coupled communication interface of the first electronic device, identity information of the first electronic device may be transmitted via the body of the user to another device. Being in the “direct vicinity of” is a very intuitive way for a human to select or identify a specific apparatus. The “direct vicinity of” may also mean that the user touches the first body coupled communication interface and touching is an even more intuitive way of pointing to a specific first electronic device. By transmitting the identification data via the body of the user, the first electronic device provides information to such another device which prevents that the user has to preselect at the another device which device is going to be controlled. Thus, the first electronic device creates the circumstances in which the another device is capable of operating in a more user friendly way: when the user is in the direct vicinity of the first electronic device and the another device, information about the identity of the first electronic device can be transmitted to the another device and, thus, the user does not have to preselect which type or which specific device is going to be controlled with the another device.

Optionally, the maximum distance is closer than 5 cm. Optionally, the maximum distance is closer than 2 cm. In an optional embodiment of the invention, direct vicinity means that the user touches the first body coupled communication interface.

Optionally, the first body coupled communication interface is also configured to receive control data via de body transmission channel.

According to another aspect of the invention, a system is provided which comprises a first electronic device according to an aspect of the invention and which comprises a second electronic device according to an aspect of the invention. The system according to another aspect provides a user friendly way of controlling the first electronic device. A user touches the first electronic device and the second electronic device simultaneously, or is with his body simultaneously in the direct vicinity of the first electronic device and the second electronic device, and, subsequently, a control user interface being related to the first electronic device is being presented to the user with help of the user interface presentor of the second electronic device. Touching two devices simultaneously, or being simultaneously present with the body in the direct vicinity of the two devices, is a very intuitive way of communicating to the devices that the user wants to control the first electronic device by the second electronic device.

Optionally, the user interface presentor is a display and the second electronic device is also configured to present different types of content on the display. The controller of the second electronic device is configured to obtain the control user interface on basis of the received identification data and on basis of the type of content being presented on the display at the moment in time when the user is simultaneously in the direct vicinity of the body coupled communication interfaces of the first electronic device and of the second electronic interface. The second electronic device becomes even more user friendly when the content that is being presented on the display is taken into account in the process of obtaining and selecting the control user interface. For example, the first electronic device might be a digital photo frame which continuously presents a series of pictures in a slide show. When, for example, a photo is presented on the display of the second electronic device and the user simultaneously touches or is simultaneously in the direct vicinity of the digital photo frame and the second electronic device, a control user interface appears which comprises the control option “add current photograph to slide show”. This option is not shown when no photograph is being presented on the display of the second electronic device. It prevents that specific controlling options of the control user interface are useless in a specific context and it makes the controlling of the first electronic device even more intuitive.

Optionally, the first electronic device comprises a plurality of first body coupled communication interfaces positioned close to different functional units of the first electronic device, and each first body coupled communication interface also transmits functional unit identity data being related to the identity of the functional unit with the identification data to the second electronic device. The second electronic device obtains the control user interface in dependence of the received identity data of the first electronic device and the functional unit identity data. Thus, the presented control user interface relates to a specific functional unit which is touched by the user, or to the specific functional unit which is in the direct vicinity of the user. In an example, the first electronic device is a jukebox, which comprises the function units “loudspeaker” or “CD rack” and when the user touches the loudspeaker, the presented user interface relates to volume and sound quality, and when the user touches the CD rack, the presented user interface relates to selecting the CD which is going to be played by the jukebox.

Optionally, the first electronic device comprises a first wireless transceiver for communicating with another device via a wireless transmission channel, the second electronic device comprises a second wireless transceiver for communicating with another device via the wireless transmission channel, the first body coupled communication interface is configured to transmit connection set-up data for setting up a wireless connection via the first wireless transceiver via the body transmission channel, the second body coupled communication interface is configured to receive connection set-up data via the body transmission channel, the controller of the second electronic device is configured to control the creation of a wireless connection between the second wireless transceiver and the first wireless transceiver using the received connection set-up data, and the second electronic device is configured to transmit the control data via the wireless connection. This optional embodiment provides the advantage that, once the wireless connection has been created, the user does not continuously have to touch both electronic devices to be able to control the first electronic device by the second electronic device or does not continuously have to be in the direct vicinity of both body coupled communication interfaces. Especially in situation wherein a user is not capable of providing the input to the second electronic device, while touching or being in the direct vicinity of both body coupled communication interfaces at the same moment in time, it is advantageous to communicate the control data via a separately created wireless connection. The wireless communication technique may be one of the wireless IEEE 802.x technologies, or, in another example, a Bluetooth connection. Particular embodiments of the invention are not limited to the above given wireless technologies and other wireless communication technologies may be used as well. In a home network, for example, all devices may be connected to a home wifi network and the communicated identification data comprises the IP-address of the first electronic device. If this information is known, the second electronic device may contact the first electronic device via the home wifi network using the IP-address and request the control user interface.

Optionally, the system further comprises a server for storing user interfaces of different electronic device. The server comprises a network interface for connecting to a specific network and the server is configured to provide to the second electronic device the control user interfaces related to the first electronic device in response to receiving a request for providing a control user interface for the first electronic device. The second electronic device also comprises a network interface for connecting to the specific network. Furthermore, the second electronic device is configured to send, while obtaining the control user interface related to the first electronic device, the request to the server via the specific network.

It may be advantageous to obtain control user interfaces from a central server, because the server may always have the latest and best version of the control user interface available. Furthermore, the server may store several versions which are, for example, adapted to specific capabilities of the second electronic device (e.g., which control user interface protocols the second electronic device supports). It might even be that the server is being contacted in addition to obtaining the control user interface from the internal memory of the second electronic device, for example, to check whether a newer version of the control user interface has become available.

According to an aspect of the invention, a method of controlling a first electronic device is provided. The method comprises the stages of a) transmitting identification data related to an identity of the first electronic device via a body transmission channel following a body of a user who is in the direct vicinity of a first body coupled communication interface of the first electronic device, b) receiving the identification data at a second body coupled communication interface of a second electronic device via the body transmission channel following a body of a user who is with his body simultaneously in the direct vicinity of the first body coupled communication interface and the second body coupled communication interface, the direct vicinity of the body to the respective body coupled communication interfaces is defined as a maximum distance between the body and, respectively, the first body coupled communication interface and the second body coupled communication interface at which the respective body coupled communication interfaces are capable of transmitting and/or receiving data via the body transmission channel, c) obtaining a user interface related to the first electronic device in response to the reception of the identification data, and d) presenting the obtained user interface to the user with help of the user interface presentor of the second electronic device.

The method according to an aspect of the invention provides the same benefits as the electronic devices and the system according to the first to an aspect of the invention and has similar embodiments with similar effects as the corresponding embodiments of the electronic devices and the system.

Optionally, the method also comprises the stages of e) receiving user input related to the presented user interface at a input reception means of the second electronic device, f) transmitting control data from the second electronic device to the first electronic device after user input has been received, the control data is based on the received user input, g) receiving the control data at the first electronic device, and h) controlling the operation of the first electronic device in accordance with the received control data.

According to an aspect of the invention, a computer program product has been provided which comprises instructions for causing a processor system to perform one of the methods of a aspect of the invention.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

Modifications and variations of the devices, the system, the method, and/or of the computer program product, which correspond to the described modifications and variations of the devices and/or the system, can be carried out by a person skilled in the art on the basis of the present description.

### BRIEF DESCRIPTION OF THE DRAWINGS

In the drawings:

FIG. 1 schematically shows an embodiment of a system according to an aspect of the invention which comprises a first electronic device according to an aspect of the invention and a second electronic device according to an aspect of the invention,

FIG. 2a schematically shows another embodiment of a system,

FIG. 2b schematically shows the displaying of a user interface which might depend on the presented content on the display,

FIG. 3 schematically shows in a diagram the communication between difference devices of the system and action performed by the different devices, and

FIG. 4 schematically shows a method according to an aspect of the invention.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION OF THE EMBODIMENTS

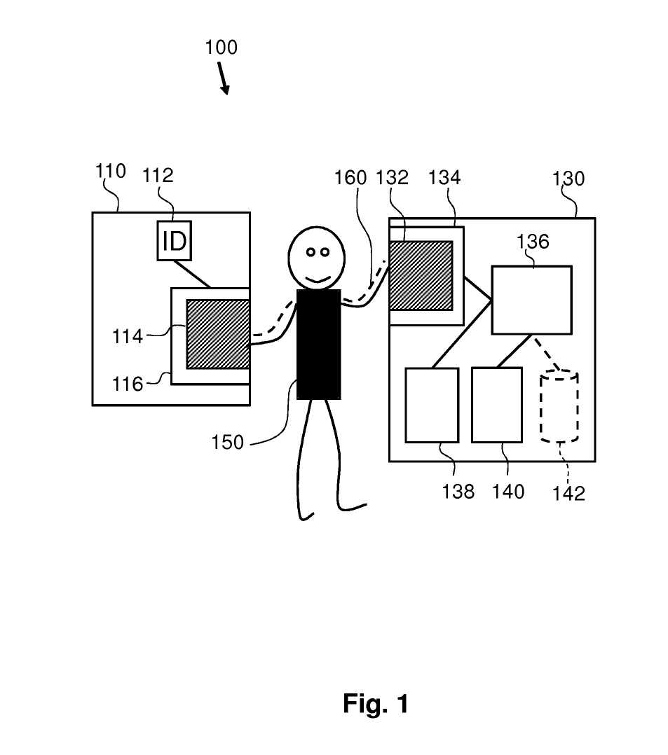

FIG. 1 schematically shows an embodiment of a system 100 according to an aspect of the invention which comprises a first electronic device 110 according to an aspect of the invention and a second electronic device 120 according to an aspect of the invention.

The first electronic device 110 comprises a body coupled communication interface 116 which comprises, for example, an electrode 114 which may be touched by a user. The first electronic device 110 also comprises an ID 112 which is data which relates to the identity of the first electronic device 110. The ID 112 is, for example, a type number indicating the type of the device, or it is a device specific serial number of the first electronic device. The body coupled communication interface 116 is configured to transmit identification data which relates to the identity of the first electronic device 110 via a body transmission channel 160 following a body of a user 150 who touches the first body coupled communication interface 116. More particular, the user 150 may touch the electrode 114 of the first body coupled communication interface 116. The identification data is based on the ID 112.

The second electronic device 130 comprises a display 138, an input reception means 140, a second body coupled communication interface 134 and a controller 136. The display 138 is capable of displaying a user interface to the user 150. The input reception means 140 is for receiving user input from the user 150. The second body coupled communication interface 134 comprises, for example, an electrode 132. The second body coupled communication interface 134 is configured to receive the identification data via the body transmission channel 160 following the body of the user 150 who touches the first body coupled communication interface 116 of the first electronic device 110 and the second body coupled communication interface 134 simultaneously. The controller 136 is configured to obtain a control user interface related to the first electronic device in response to receiving the identification data of the first electronic device. The controller 136 is also configured to present the obtained control user interface on the display 138.

The system 100 uses body coupled communication, which means that, via the body of the user 150 a body transmission channel 160 is formed through which data may be transmitted between two body coupled communication interfaces 114, 134. Details of such techniques may be found in other documents, such as, for example, U.S. Pat. No. 6,211,799 or U.S. Pat. No. 5,914,701. Depending on the specific implementation, the body coupled communication interfaces 116, 134 comprise an electrode 114, 132 which must be touched by the user 150. In other implementation a direct electrical contact with the body is not necessary and is, for example, capacitive coupling used as a means to transmit information via the body transmission channel 160. In the context of this document it is only important that, when a user touches two body coupled communication interfaces 116, 134 of different electronic devices 110, 130, data may be transmitted between the first electronic device 110 and the second electronic device 130 and that the data is not transmitted to other devices. Thus, the body transmission channel 160 is selective: only if there is a touch contact with a specific electronic device, this device may transmit or receive data via the body transmission channel 160.

In the system 100 of FIG. 1 the operation of the invention comprises, for example, the following steps: the user 160 touches simultaneously the first body coupled communication interface 116 and the second body coupled communication interface 134; subsequently the first body coupled communication interface 116 transmits identification data based on the ID 112 of the first electronic device 110 via the body transmission channel 160 towards the second body coupled communication interface 134; the second body coupled communication interface 134 receives the identification data and forwards the identification data to the controller 136; subsequently the controller 136 uses the identification data to select and/or obtain the control user interface which may be used by the user 150 to control the first electronic device 110; thereafter, the obtained control user interface is provided to the display 138 which displays the obtained control user interface.

When the controller 136 selects and/or obtains the control user interface, the controller 136 may, for example, obtain the control user interface from an internal storage 142 of the second electronic device 130. In other embodiments, the second electronic device 130 may request the first electronic device 110, via the body transmission channel 160, to provide the control user interface which is subsequently transmitted by the first electronic device 110 towards the second electronic device 110 via the body transmission channel 160. The second electronic device 130 may also request the first electronic device 110 to provide the control user interface via another communication channel than the body transmission channel 160.

In an additional embodiment, the user may provide, via the input reception means 140, control input in relation to the displayed control user interface. Subsequently, the second electronic device 130 transmits control data, which is based on the received control input, towards the first electronic device 110. The first electronic device 110 receives the control data and uses the control data to control its operation in accordance with the received data. The transmission of the control data may also be performed via the body transmission channel 160, however, in other embodiments, other communication channels between the first electronic device 110 and the second electronic device 130 may be used. The second electronic device 130 may generate the control data on basis of information which is, for example, available in the control user interface. Or the control data may be generated on basis of predefined standards. For example, then the control user interface is a sort of HTML based webpage, the HTML webpage may comprise information which has to be sent to the first electronic device when a specific button is pressed.

The first electronic device 110 may be any electronic device which may be controlled. This includes all devices which do not provide a direct control interface to the user. For example, the first electronic device 110 may be a luminaire which comprises a dimmer and the second electronic device 130 may be used to control the emitted light intensity. For example, the first electronic device 110 may also be an amplifier which amplifies a received audio signal and provide the amplified signal to loudspeakers. In such an embodiment, the second electronic device may be used to control the sound intensity. For example, the first electronic device may also be an electronic device which has its own control buttons or has its own remote controller, such as a display or a television set. The second electronic device may be used as a universal remote controller for these devices without having the need to preselect which first electronic device is going to be controlled.

It is to be noted that in the above provided description of the embodiment of FIG. 1 it has been described that the first electronic device 110 and the second electronic device 130 are able to communicate via the body transmission channel 160 when the user 150 touches the respective body coupled communication interfaces 116, 134. However, body coupled communication is not limited to a touch of the body coupled communication interface—in specific embodiments of the body coupled communication technology, the body of the user 150 must be in the direct vicinity of the respective body coupled communication interfaces 116, 134 to transmit and receive data via the body transmission channel 160. Direct vicinity means that the body is within a maximum distance of the respective body coupled communication interfaces 116, 134. The maximum distance may be 5 centimeters, or, for example, 2 centimeters, or 1 centimeter. The detection that the user touches the respective body coupled communication interfaces 116, 134, or the detection that the user is in the direct vicinity of the respective body coupled communication interfaces 116, 134 may be performed by measuring sudden changes in specific characteristics of electrodes 114, 132, or by measuring with a specific additional element the presence of the body of the user 150. In the following of this document, at locations where “touching the electronic device” or “touching the body coupled communication interface” is described, one may also read “the body of the user is in the direct vicinity of the body coupled communication device”.

In the above described embodiment of FIG. 1 and in the following embodiments, the second electronic device 130 comprises a display 138. However, it is to be noted that the invention is not limited to second electronic device 130 which comprise a display. It is only necessary that the second electronic device 130 is capable of presenting the control user interface. Presenting must be interpreted broadly: the user must be able to perceive the presented control user interface. Instead of, or in addition to presenting on a display different control options, the second electronic device may also present in an audible way the different control options.

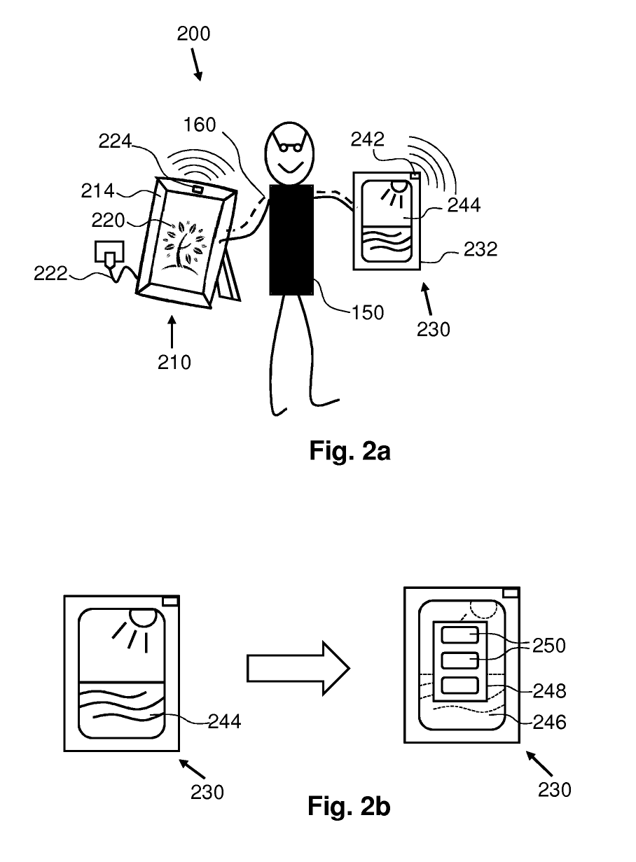

FIG. 2a schematically shows another embodiment of a system 200. The system 200 comprises an electronic photo frame 210 which comprises all elements (not shown) of the first electronic device 110 of FIG. 1, and which further comprises a display for presenting a picture, a frame 214, a power connection 222 to the mains power and a first wireless communication interface 224. The frame 214 is an integral part of the first body coupled communication interface (not shown). The frame 214, is, for example, made of a metal which forms an electrode of the first body coupled communication interface. The system 200 further comprises a tablet computer 230 which comprises all elements (not shown) of the second electronic device 130 of FIG. 1, and which further comprises a housing 232 which is partially electrically conductive, and which further comprises a second wireless communication interface 242. The housing 232 forms an integral part of the second body coupled communication interface (not shown). Because the housing is at least partially electrically conductive, the housing is a sort of electrode of the second body coupled communication interface. The display of the tablet computer 230 is also touch sensitive for receiving user input. In other words, the display and the user input reception means are integrated in a specific touch sensitive display. A processor of the tablet computer 230 may perform the tasks of the controller of the second electronic device and the internal memory or hard disk form the internal storage of the tablet computer 230.

In the system 200 of FIG. 2, not only identification data of the electronic photo frame 210 is transmitted via the body transmission channel 160 but also connection set-up data which comprises enough information for the tablet computer 230 to set up a wireless network connection between a the second wireless interface 242 and the first wireless interface 224. The connection set-up data may comprise, for example, a security key for establishing the wireless network connection, and/or information about the channels at which the first wireless interface 224 operates, and/or the network identification name of the first wireless interface 224, etc. Thus, when the user 150 simultaneously touches the frame 214 of the electronic photo frame 210 and the housing 232 of the tablet computer 230, identification data and connection set-up data are transmitted from the electronic photo frame 210 towards the tablet computer 230. The received identification data is used to select and/or obtain a control user interface which relates to the electronic photo frame 210, and the received connection set-up data is used to establish the wireless network connection via the wireless interfaces 224, 242 between the electronic photo frame 210 and the tablet computer 230. The established wireless network connection may be used to communicate information between the electronic photo frame 210 and the tablet computer 230. This information may include a request from the tablet computer 230 to the electronic photo frame 210 to provide the control user interface and/or control data to control the electronic photo frame 210. Also other data, such as pictures may be transferred via the established wireless network connection. It is advantageous to establish, in addition to the body transmission channel 160, another wireless network connection to increase the capacity of the communication channels between the two device 210, 230 and/or to allow the user to release one of his hands from the frame 214 of the electronic photo frame 210 such that he is able to provide input to the tablet computer 230 with both hands. Examples of wireless communication technologies, which may be used to communicate via the wireless network connection, are Bluetooth, Wifi (wireless communication according to one of the 802.11 protocols), Zigbee (or other wireless communication protocol according to one of the 802.15 protocols), WiMax (Broadband Wireless Access—IEEE 802.16 standard), UMTS, LTE, etc.

The system 200 of FIG. 2a provides also another specific embodiment. The display of the tablet computer 230 is, in addition to presenting an user interface, also capable of showing other content, such as a picture 244 or a video. When such other content is presented and the user touches simultaneously the electronic photo frame 210 and the tablet computer 230, the controller of the tablet computer 230 does not only use the received identification data as a condition for selecting and/or obtaining the control user interface which relates to the electronic photo frame 210, but it uses also the presented content as a selection criterion. For example, when a picture is presented on the display of the tablet computer 230, the control user interface shall include the option “add current picture to slide show of photo frame”. Or when a video is presented, the control user interface shall include the option “add current frame of video to slide show photo frame”, or when the electronic photo frame 210 is also capable of presenting video's, an additionally presented option in the control user interface might be “add current video to slide show of photo frame”. In other words, the tablet computer 230 presents a context aware control user interface when the user touches both devices 210, 230 at the same moment in time. The tablet computer 230 might have stored several control user interfaces in its internal storage, or, when the tablet computer 230 requests from the electronic photo frame 210 or from a sever connected to a network to which the tablet computer 230 is also connected, a request to provide the control user interface includes information related to the type of information that is being displayed at the display of the tablet computer 230. Thereby the appropriate control user interface may be provided by the electronic photo frame 210 or the server. It is to be noted that the use of the content being presented on the display does always result in the presentation of a different control user interface if a different type of content is being presented, for example, when the other device is not capable of handling the specific content being presented on the display of the tablet computer 230.

In another optional embodiment, the electronic photo frame 210 provides to the tablet computer 230 information about its capabilities. This information may be send via the body transmission channel 160 or via another established (wireless) communication channel. The information of capabilities comprises, for example, whether the electronic photo frame 210 is able to store additional pictures for presentation in the slide show, whether the electronic photo frame 210 is capable of presenting video files, etc. This information may be used by the tablet computer 230 to obtain/select the appropriate control user interface. It may be used by the table computer 230 to add specific options to the control user interface or to remove specific options.

FIG. 2b schematically shows the displaying of a user interface 248 which might depend on the presented content 244 on the display of the tablet computer 230. At the left end of FIG. 2b the tablet computer 230 presents a picture 244. When, subsequently, the user 150 touches the electronic photo frame 210 and the tablet computer 230 at the same moment in time, the presented information on the display of the tablet computer 230 changes towards, for example, the situation shown at the right end of FIG. 2b. At the right end, in the background a picture 246 is presented which is similar to the picture 244, but changed, for example, to grey-levels only, or to another brightness level. At the foreground the control user interface 248 which relates to the electronic photo frame 210 is presented. The control user interface 248 comprises, for example, different buttons 250 which might be touched by the user. The button 250 are, for example, “start slide show”, “switch off”, “increase intensity”, “decrease intensity”, and, in this specific example, also a button 250 for “add current picture to slideshow”. If, at the specific moment in time at which the user simultaneously touched the electronic photo frame 210 and the tablet computer 230 no specific content was presented on the display of the tablet computer, the option “add current picture to slideshow” is not present in the displayed control user interface 248.

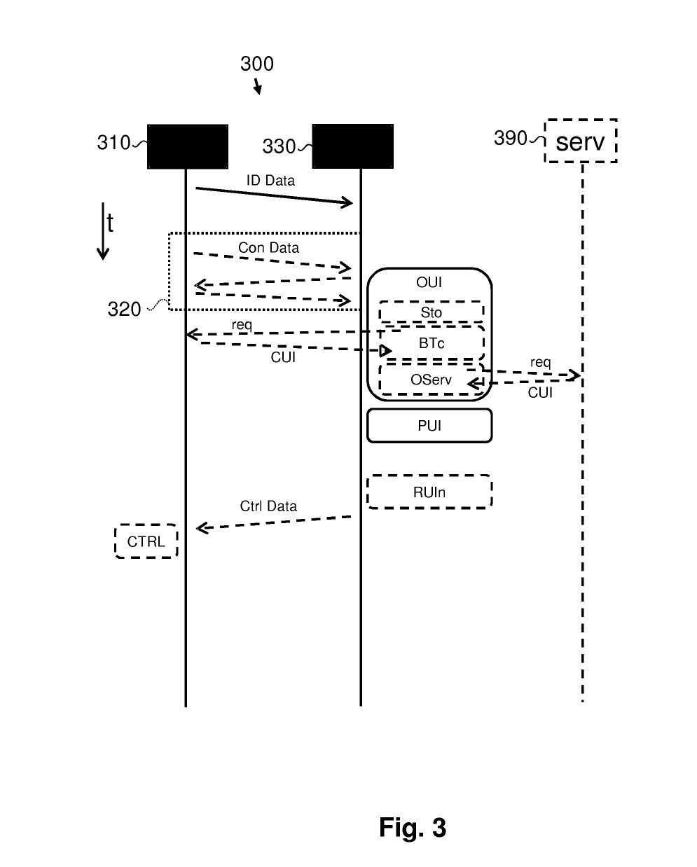

FIG. 3 schematically shows in a sort of sequence diagram 300 the communication between difference devices of the system and action performed by the different devices. The vertical direction of the diagram 300 represents the dimension of time. At the left end a first line is drawn which relates to the first electronic device 310, in the middle a second line is drawn which relates to the second electronic device 330 and at the right end a third line is drawn which relates to an optional server 390. The first electronic device 310 may be an electronic device according to the embodiments discussed in the context of FIG. 1 and FIG. 2a. The second electronic device may be an electronic device according to the embodiments discussed in the context of FIG. 1 and FIG. 2a. If in between the first line and the second line an arrow is drawn, the arrow represents communication of information between the first electronic device 310 and the second electronic device 330, or vice versa. If in between the second line and the third line an arrow is drawn, the arrow represents the communication of information between the second electronic device 330 and the server 390, or vice versa. Immediately right of the second line some actions executed by the second electronic device 330 are schematically represented by rounded boxes. If arrows or boxes are drawn with a dashed line, they are optional.

The diagram 300 starts at the moment in time (not shown) that a user touches simultaneously the first body coupled communication interface of the first electronic device 310 and the second body coupled communication interface of the second electronic device 330. This event is followed by the transmission of identification data “ID Data” from the first device 310 to the second device 330 via a body transmission channel (as discussed previously).

Optionally, the sending of the identification data “ID Data” may be followed by some communication 320 which relates to setting up a wireless network connection. The communication 320 relating to setting up a wireless network connection starts with sending connection set-up data “Con Data” from the first device 310 to the second device 330 via a body transmission channel. Subsequently, the second electronic device 330 connects the first electronic device 310 via a wireless transmission medium and the establishing of the connection may be confirmed by the first electronic device 310 via the wireless transmission medium. It is to be noted that the communication 320 which relates to setting up the wireless network connection may also be performed later in time and it is not necessary the first type of communication that follows after sending the identification data “ID data”. The communication 320 may also be performed in parallel with other actions undertaken by the first electronic device 310 and/or the second electronic device 330.

After receiving the identification data “ID Data”, a controller of the second electronic device 330 obtains and/or selects “OUI” on basis of the received identification data “ID Data” a control user interface which relates to the first electronic device 310. Three different embodiments of obtaining and/or selecting “OUI” are drawn in FIG. 3. In a first embodiment “Sto”, the second electronic device 300 obtains the control user interface from its own internal storage. In the internal storage several control user interface may be stored and on basis of the received identification data “ID Data”, the correct control user interface is selected. In a second embodiment “BTc”, the second electronic device 300 obtains the control user interface via the body transmission channel from the first electronic device 310. To do so, the second electronic device 330 sends a request “req” to the first electronic device 310 which may result in a reply from the first electronic device 310 which sends its own control user interface “CUI” to the second electronic device 330. In an alternative second embodiment, the transmission of the request and the control user interface is performed via an earlier established wireless network connection. In a third embodiment “OServ”, the second electronic device 300 obtains the control user interface from a server 390 via a specific network to which the second electronic device 330 and the server 390 are connected. To do so, the second electronic device 330 sends a request “req” to the server 390 to provide a control user interface being related to the first electronic device 310 and the server 390 replies by sending the correct control user interface “CUI” to the second electronic device 330.

Subsequently, the second electronic device 330 presents “PUI” the obtained/selected control user interface on its display.

Optionally, at the second electronic device 330 receives “RUIn” from the user user input which relates to the presented control user interface. The received user input is the basis for the control data “Ctrl Data” which is transmitted subsequently to the first electronic device 310. This transmission may be performed via the body transmission channel or via an earlier established wireless network connection between the two devices 310, 330. The reception of control data “Ctrl Data” at the first electronic device is followed by the action of controlling “CTRL” the operation of the first electronic device 310.

In an alternative embodiment of the system for controlling a first electronic device, the first electronic device comprises several functional units and each function unit is provided with a first body coupled communication interface. These first body coupled communication interfaces are configured to transmit, together with identity data of the first electronic device, also an identity indication of the function unit such that the second electronic device is capable of obtaining a user interface which relates to the specific function unit and to the specific first electronic device. For example, the first electronic device is a television. When the user touches the display unit, a user interface is presented to the user which relates to controllable characteristics of the display unit such as brightness, contrast, color balance, etc. When the user touches the loudspeaker unit, another user interface is presented to the user which relates to controllable characteristics of the audio, such as volume, sound quality, etc.

In an alternative embodiment of the system for controlling the first electronic device, the first electronic device is a payment unit in a shop. When the user touches the payment unit and simultaneously touches his mobile phone, at least the identification data of the payment unit is transferred to the mobile phone, and the mobile phone presents a payment user interface in the style of the shop in which the payment unit is installed. In this embodiment, the body transmission channel may be used to securely transmit other data which relates to the payment transactions, such as account information, public keys, amount to be paid, etc. The presented payment user interface allows the user to provide control input which is, for example, a confirmation that the payment terminal may deduct the payment amount from the account of the user.

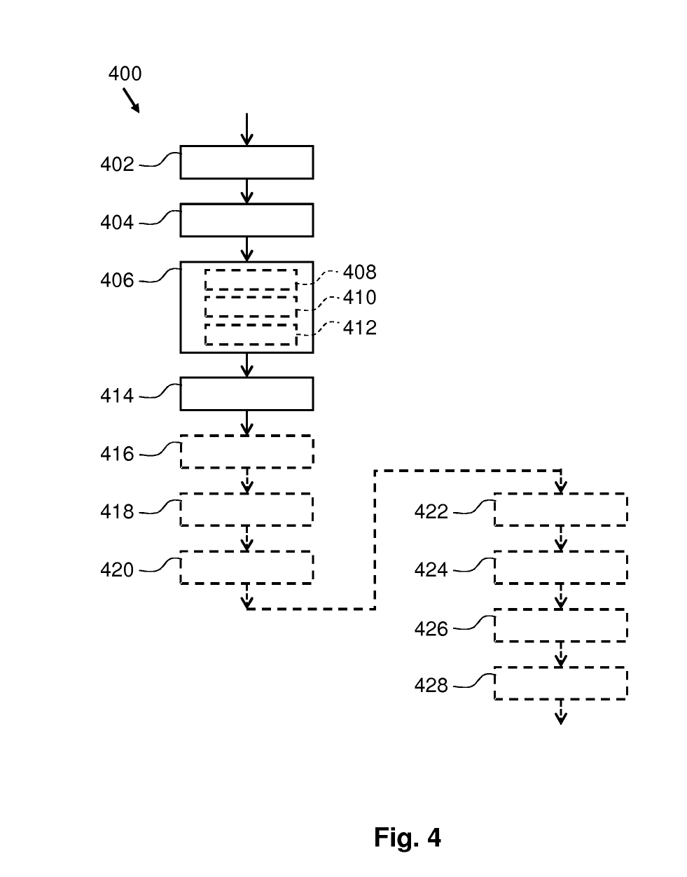

FIG. 4 schematically shows a method 400 according to an aspect of the invention. The method comprises the stages of: a) transmitting 402 identification data related to an identity of the first electronic device via a body transmission channel following a body of a user who touches a first body coupled communication interface of the first electronic device, b) receiving 404 the identification data at a second body coupled communication interface of a second electronic device via the body transmission channel following a body of a user who touches the first body coupled communication interface and the second body coupled communication interface simultaneously, c) obtaining 406 a control user interface related to the first electronic device in response to the reception of the identification data, d) presenting 414 the obtained control user interface on a display of the second electronic device.

The stage of obtaining 406 a control user interface may comprise at least one of the subsequent sub stages: i) obtaining 408 the control user interface from an internal storage medium of the second electronic device, ii) obtaining 410 the control user interface from the first electronic device via the body transmission channel or via another communication channel being present between the first electronic device and the second electronic device, and iii) obtaining 412 the control user interface from a server which is coupled to a network to which the second electronic device is also coupled.

In an optional embodiment, parallel to the stages 404, 406, 414, or after presenting 414 the control user interface, the subsequent stages of the method 400 are performed: e) transmitting 416 connection set-up data from the first electronic device via the body transmission channel, f) receiving 418 the connection set-up data at the second electronic device and g) establishing 420 a wireless network connection between the first electronic device and the second electronic device.

In an optional embodiment, the method 400 further comprises the stages of h) receiving 422 user input related to the presented user interface at an input reception means of the second electronic device, i) transmitting 424 control data from the second electronic device to the first electronic device after user input has been received, the control data is based on the received user input, j) receiving 426 the control data at the first electronic device, and k) controlling 428 the operation of the first electronic device in accordance with the received control data.

In summary, a first electronic device, a second electronic device and a system comprising the first and the second electronic device are provided. Also a method of controlling the first electronic device and a computer program for performing the method are provided. The first electronic device and the second electronic device each comprise a body coupled communication interface and when a user is in the direct vicinity of both body coupled communication interfaces, the first electronic device transmits via a body transmission channel identification data to the second electronic device. Subsequently the second electronic device obtains on basis of the received identification data a control user interface. The obtained control user interface is presented on a user interface presentor of the second electronic device.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electronic device, comprising:
display for presenting a user interface to a user to control another electronic device, wherein the user receives user input via the electronic device;
a second body coupled communication interface configured to receive identification data via a body transmission channel following a body of the user who is in a direct vicinity of a first body coupled communication interface of said another electronic device and the second body coupled communication interface, the direct vicinity defined as a maximum distance between the body of the user and, respectively, the first body coupled communication interface and the second body coupled communication interface at which the respective body coupled communication interfaces are capable of transmitting and/or receiving data via the body transmission channel; and
a controller configured to obtain, in response to receiving the identification data of said another electronic device, a control user interface to control said another electronic device and configured to present the obtained control user interface via the display.

2. The electronic device according to claim 1, further configured to transmit control data to said another electronic device after the user input related to the presented control user interface has been received, the control data being based on the received user input.

3. The electronic device according to claim 2, wherein the second body coupled communication interface is configured to transmit the control data via the body transmission channel following the body of the user who is in the direct vicinity of the first body coupled communication interface of said another electronic device and the second body coupled communication interface.

4. The electronic device according to claim 1, wherein the controller is configured to obtain the control user interface related to said another electronic device from an internal storage of the electronic device, from said another electronic device via the body transmission channel or another communication channel between said another electronic device and the electronic device, or from a server via a network.

5. The electronic device according to claim 1, further configured to present different types of content on the display, and wherein the controller is configured to obtain the control user interface on basis of the received identification data and on basis of the type of content being presented on the display at the moment in time when the user is in the direct vicinity of the first body coupled communication interface of said another electronic device and the second body coupled communication interface.

6. A first electronic device for receiving control data, comprising:
a first body coupled communication interface configured to transmit identification data related to an identity of the first electronic device via a body transmission channel following a body of a user, the body of the user being in a direct vicinity of the first body coupled communication interface and a second body coupled communication interface of a second electronic device configured to receive the identification data via the body transmission channel, the direct vicinity being defined as a maximum distance between the body of the user and the first body coupled communication interface at which the first body coupled communication interface is capable of transmitting and/or receiving data via the body transmission channel, wherein the first electronic device is further configured, after transmitting the identification data, to receive control data from the second electronic device and to control the operation of the first electronic device.

7. The first electronic device according to claim 6, wherein the first body coupled communication interface is configured to receive the control data via the body transmission channel.

8. A system, comprising:
a first electronic device that includes a first body coupled communication interface configured to transmit identification data related to an identity of the first electronic device via a body transmission channel following a body of a user;
a second electronic device, wherein the body of the user is in a direct vicinity of the first body coupled communication interface and a second body coupled communication interface of the second electronic device configured to receive the identification data via the body transmission channel, the direct vicinity being defined as a maximum distance between the body of the user and the first body coupled communication interface at which the first body coupled communication interface capable of transmitting and and/or receiving data via the body transmission channel and wherein the first electronic device is further configured, after transmitting the identification data, to receive control data from the second electronic device and to control the operation of the first electronic device.

9. The system according to claim 8, wherein
the first electronic device comprises a first wireless transceiver for communicating with another device via a wireless transmission channel;
the second electronic device comprises a second wireless transceiver for communicating with said another device via the wireless transmission channels;
the first body coupled communication interface is configured to transmit connection set-up data for setting up a wireless connection via the body transmission channel;
the second body coupled communication interface is configured to receive the connection set-up via the body transmission channel;
the controller of the second electronic device is configured to control the wireless connection between the second wireless transceiver and the first wireless transceiver using the received connection set-up data; and
the second electronic device is configured to transmit the control data via the wireless connection.

10. The system according to claim 8, further comprising a server for storing control user interfaces of different electronic devices, the server comprising a network interface for connecting to a specific network, the server being configured to provide to the second electronic device the control user interface related to the first electronic device in response to receiving a request for providing a control user interface for the first electronic device, wherein the second electronic device further comprises another network interface for connecting to the specific network and the second electronic device is configured to send, while obtaining the control user interface related to the first electronic device, the request to the server via the specific network.

11. A method of controlling a first electronic device from a second electronic device, comprising:
transmitting identification data related to an identity of the first electronic device via a body transmission channel via a first body coupled communication interface of the first electronic device,
receiving the identification data at a second body coupled communication interface of a the second electronic device via the body transmission channel the body transmission channel following a body of a user who is in the direct vicinity of the first body coupled communication interface and the second body coupled communication interface, the direct vicinity being defined as a maximum distance between the body of the user and, respectively, the first body coupled communication interface and the second body coupled communication interface at which the respective body coupled communication interfaces are capable of transmitting and/or receiving data via the body transmission channel,
obtaining a control user interface to control the first electronic device in response to receiving the identification data, and
presenting the obtained control user interface on a display of the second electronic device.

12. The method according to claim 11, further comprising:
receiving user input related to the presented user interface at the second electronic device,
transmitting control data from the second electronic device to the first electronic device after the user input has been received, the control data being based on the received user input,
receiving the control data at the first electronic device,
controlling the first electronic device in accordance with the received control data.

13. A non-transitory computer readable storage medium containing a program comprising instructions for causing a processor to carry out a method of controlling a first electronic device from a second electronic device comprising:
transmitting identification data related to an identity of the first electronic device via a body transmission channel via a first body coupled communication interface of the first electronic device;
receiving the identification data at a second body coupled communication interface of the second electronic device via the body transmission channel, the body transmission channel following a body of a user who is in the direct vicinity of the first body coupled communication interface and the second body coupled communication interface, the direct vicinity being defined as a maximum distance between the bad of the user and, respectively, the first body coupled communication interface and the second body coupled communication interface at which the respective body coupled communication interfaces are capable of transmitting and/or receiving data via the body transmission channel;
obtaining a control user interface to control the first electronic device in response to receiving the identification data; and
presenting the obtained control user interface on a display of the second electronic device.
